(19) United States
(12) Patent Application Publication
(10) Pub. No.: US 2018/0034787 A1
(43) Pub. Date: Feb. 1, 2018

(54) DATA ENCRYPTION KEY SHARING FOR A STORAGE SYSTEM

(71) Applicant: Vormetric, Inc., San Jose, CA (US)

(72) Inventors: Ashvin Kamaraju, San Jose, CA (US); Masoud Sadrolashrafi, San Jose, CA (US); Sridharan Sudarsan, San Jose, CA (US); I-Ching Wang, San Jose, CA (US)

(21) Appl. No.: 15/225,674

(22) Filed: Aug. 1, 2016

(51) Int. Cl. H04L 29/06

(52) U.S. Cl. CPC H04L 63/0464; H04L 63/061; H04L 63/168

(57) ABSTRACT

A method for key sharing with a storage system, performed by a network device or security manager is provided. The method includes sharing a first key with a host system and sharing the first key with a storage system. The host system encrypts a file or data with the first key and sends the encrypted file or data to the storage system. The storage system decrypts the encrypted file or data with the first key, compresses the decrypted file or data, and re-encrypts the decrypted file or data.

### BACKGROUND

Cyber attacks continue to grow more sophisticated and persistent. To combat threats and keep data safe, Information technology (IT) teams have to employ robust encryption, key management, and access controls. This is especially true for information held in storage environments, which can contain an organization's most vital assets. To secure storage, many organizations have been leveraging native encryption offerings from their storage vendors. The growing trend with “all flash” storage array deployments in enterprises pose particular challenges when encrypted data from host servers have to be stored in these arrays. Flash storage arrays offer high performance and capabilities like compression and deduplication for storage efficiency. With sophisticated encryption algorithms that extend beyond simple substitution ciphers, encrypted data tends not to compress as much, and tends to not yield as much reduction in storage, as when deduplication and/or compression are applied to unencrypted data. Many storage systems are available with deduplication and/or compression, for example in network attached storage (NAS or SAN). Yet, to supply unencrypted or plaintext data over a network to such a storage system is risky, and can result in a security breach. It is within this context that the embodiments arise.

### SUMMARY

In some embodiments, a method for key sharing with a storage system, performed by a network device or security manager is provided. The method includes sharing a first key with a host system and sharing the first key with a storage system. The host system encrypts a file or data with the first key and sends the encrypted file or data to the storage system. The storage system decrypts the encrypted file or data with the first key, compresses the decrypted file or data, and re-encrypts the decrypted file or data.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a system block diagram showing a data security management system managing a shared first key for a host that encrypts data with the first key, and a storage system that decrypts the data with the first key, deduplicates and compresses the decrypted data, re-encrypts the data with a storage local second key and stores the second key encrypted deduplicated, compressed data in storage memory in accordance with some embodiments.

FIG. 2 depicts internal processes of the storage system, including decryption with the first key and encryption with the second key in accordance with some embodiments.

FIG. 3 is a system block diagram showing hosts directly communicating keys to a storage system, in a further embodiment of the system of FIG. 1 without the data security management system in accordance with some embodiments.

FIG. 4 is a system diagram showing extended key sharing coordinated by a data security management system, with multiple hosts, multiple keys and multiple storage systems, in a further embodiment of the system of FIG. 1 in accordance with some embodiments.

FIG. 5 is a system diagram showing transmission of both encrypted data and encrypted metadata between host and storage system, in an embodiment applicable to variations of FIGS. 1-4 in accordance with some embodiments.

FIG. 6A depicts a modified file system communicating with the data security management system in accordance with some embodiments.

FIG. 6B depicts the host communicating with the data security management system, using messages in accordance with some embodiments.

FIG. 6C depicts the data security management system intercepting a network packet sent by the host to the storage system, and parsing the header in accordance with some embodiments.

FIG. 7 is a flow diagram of a method for key sharing, which can be performed by a data security management system in cooperation with one or more hosts and one or more storage systems in accordance with some embodiments.

FIG. 8 is a system diagram depicting a secure volume manager encrypting data and encrypting metadata, for storage in accordance with some embodiments.

FIG. 9 is a flow diagram of a method for encrypting data and metadata, which can be practiced using the system depicted in FIG. 8 and can also be practiced using the key sharing depicted in FIGS. 1-7 in accordance with some embodiments.

FIG. 10 is an illustration showing an exemplary computing device which may implement the embodiments described herein.

### DETAILED DESCRIPTION

For security reasons, it is desirable to send encrypted data over a network to a storage system, so that unencrypted data is not accessible on the network. And, for storage efficiency and storage density reasons, it is desirable to deduplicate and/or compress unencrypted data prior to storage. Also for security reasons, it is desirable to store encrypted data, not unencrypted or plaintext data, in storage memory. These preferences are addressed by various embodiments of key sharing for a storage system as disclosed herein. In common across many of these embodiments, a host encrypts data with a first key, and sends the encrypted data, e.g., over a network, to a storage system. The storage system decrypts the data, using the first key, and performs deduplication and/or compression on the unencrypted or decrypted data. Then, the storage system encrypts the resultant deduplicated and/or compressed data, with a second key that is local to that storage system, finally storing the data as deduplicated and/or compressed, and encrypted. Various embodiments thus avoid sending unencrypted data over a network, also avoid deduplicating encrypted data and compressing encrypted data, and finally avoid storing unencrypted data, hence satisfying the above preferences. A data security management system, which can be networked device, is disclosed herein as managing and sharing one or more keys for the host(s) and storage system(s) in various embodiments.

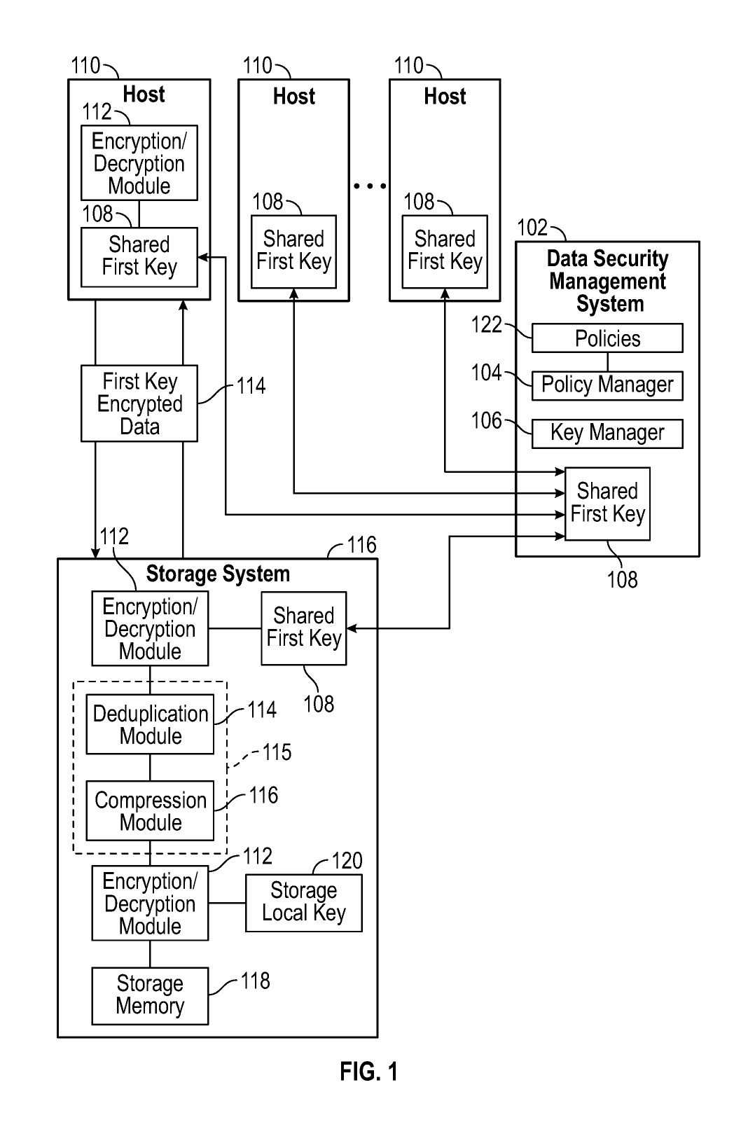

FIG. 1 is a system block diagram showing a data security management system 102 managing a shared first key 108 for a host 110 that encrypts data with the first key, and a storage system 116 that decrypts the data with the first key, deduplicates and compresses the decrypted data, re-encrypts the data with a storage local second key 120 and stores the second key encrypted deduplicated, compressed data in storage memory 118. Each host 110 and each storage system 116 is equipped with one or more encryption/decryption modules 112, which could be implemented in software executing on a processor, firmware, hardware or combinations thereof, as combined encryption and decryption, or separate encryption and decryption, etc. Each host 110 and each storage system 116 stores the shared first key 108. Each storage system 116 has a deduplication module 114 and/or a compression module 116, plus storage memory 118, and memory in which the storage local second key 120 is stored. Deduplications module 114 and compression module 116 may be combined within module 115 in some embodiments as the illustration is meant to be an example and not limiting. Key 120 is local to the storage system 116, for encryption and decryption of data stored in the storage memory 118, and is not available to any of the hosts 110 in this embodiment. All components of the system could be implemented in hardware, firmware, software executing on one or more processors, or various combinations thereof, which may be virtualized and implemented using physical computing and memory resources, in some embodiments.

The data security management system 102, which could be implemented in software executing on a processor, firmware, hardware or combinations thereof, has a policy manager 104 and a key manager 106, along with memory in which the shared first key 108 is stored. There are multiple versions of how the shared first key 108 is sourced and distributed. In a single host system, the host 110 could generate or otherwise source the shared first key 108, and send the shared first key 108 to the data security management system 102, which distributes the shared first key 108 to one or more storage systems 116 in some embodiments. In a multiple host 110 system, one host 110 could generate or otherwise source the shared first key 108, and send the shared first key 108 to the data security management system 102. The data security management system 102 then sends the shared first key 108 to the other hosts 110 and to one or more storage systems 116. In some embodiments, the data security management system 102 could generate or otherwise source the shared first key 108, and send the shared first key 108 to one or more hosts 110 and one or more storage systems 116. Further variations of sourcing and distribution for the shared first key 108 are readily devised in keeping with the teachings described herein.

The storage system 116 could be implemented using various storage technologies, and could include various types of storage memory 118 such as hard disks, flash memory or other solid-state storage, optical storage, tape, etc., and could include redundancy, error correction or other reliability enhancing technology, such as one or more levels of RAID (redundant array of independent disks or other storage devices). In one embodiment, the storage system 116 includes one or more encrypted logical units (LUNs) implemented as virtualized storage memory using physical storage and computing components. The storage system 116 has one or more encryption/decryption modules 112, or equivalently, one or more encryption modules and one or more decryption modules, a deduplication module 114, a compression module 116, storage memory 118, and memory for storing a shared first key 108 and a storage local second key 120. The storage memory 118 could include one or more storage devices of various types as discussed above, in various configurations, and is not limited to a single device type or homogeneity.

In operation, the data security management system 102 coordinates distribution of a shared first key 108. In one embodiment, the key manager 106 cooperates with the policy manager 104, to distribute the shared first key 108 in accordance with one or more policies 122 of the policy manager 104. Using the shared first key 108 that is generated or otherwise sourced by the host 110, or received by the host 110 from the data security management system 102 in some embodiments, the host 110 encrypts data by way of the encryption/decryption module 112 of the host 110. Following such encryption, the host 110 sends first key encrypted data 114 to the storage system 116, for example via a network. Upon receipt of the first key encrypted data 114, the storage system 116 uses an encryption/decryption module 112 and the shared first key 108 that is received by the storage system 116 from the data security management system 102, or generated or otherwise sourced by the storage system 116 in some embodiments, to decrypt the first key encrypted data 114. Next, the storage system 116 deduplicates the decrypted data, using the deduplication module 114, or compresses the data using the compression module 116, or both deduplicates and compresses the decrypted data, in various embodiments. After that, the storage system 116 uses either the same or another encryption/decryption module 112, and the storage local second key 120, to encrypt the deduplicated and/or compressed data, and stores the second key encrypted, deduplicated and or compressed data in the storage memory 118. The above describes the host 110 writing data to the storage system 116, for example using a write request.

For the host 110 to read data from the storage system 116, the reverse path is followed. For example, the host 110 could send a read request to the storage system 116. The storage system 116 reads the second key encrypted data from the storage memory 118, and applies the storage local second key 120 and the encryption/decryption module 116 to decrypt the data. Then, the storage system 116 uses the compression module 116 and/or the deduplication module 114 to decompress and/or reconstitute the data. Finally the storage system 116 uses the shared first key 108 and the same or another encryption/decryption module 112 to encrypt the data, and sends the first key encrypted data 114 to the host 110. The host 110 uses the shared first key 108 and the encryption/decryption module 112 of the host 110, to decrypt the first key encrypted data 114, and now has the desired read data in unencrypted or plaintext form. Other hosts 110 (in embodiments with more than one host 110) can use their own copy of the shared first key 108, as managed by the data security management system 102, to encrypt data and send data to the storage system 116, or receive first key encrypted data 114 from the storage system 116 and decrypt the data.

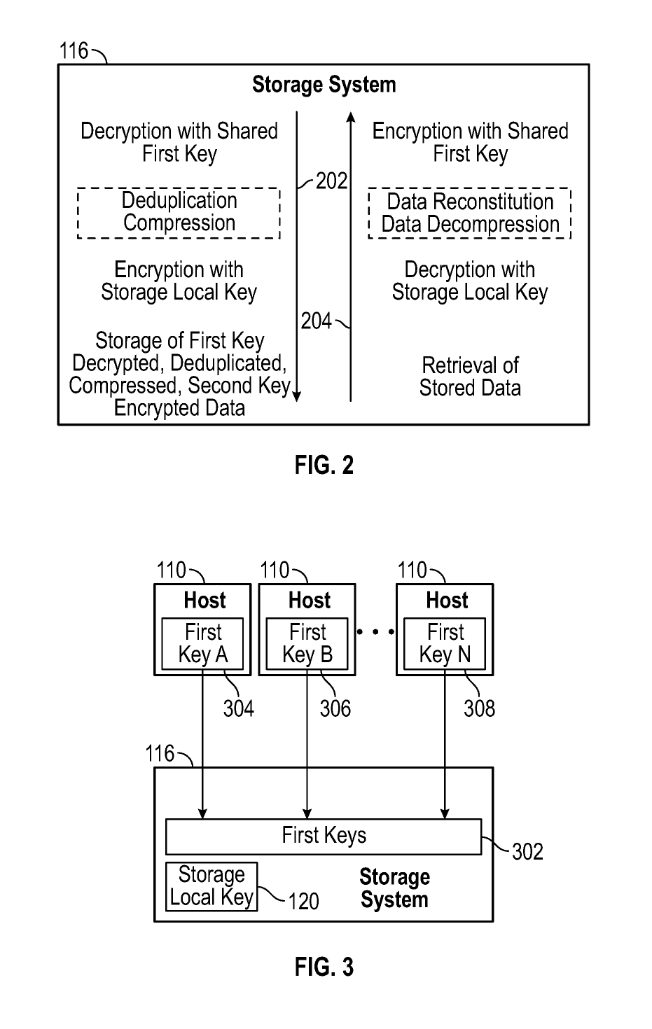

FIG. 2 depicts internal processes of the storage system 116, including decryption with the first key and encryption with the second key. Write data from the host 110 to the storage system 116 follows the write path 202 to the storage memory 118 (see FIG. 1). Thus, first key encrypted data 114 written by the host 110 to the storage system 116 has decryption with the shared first key, deduplication and/or compression, encryption with the storage local second key, and storage of the first key decrypted, deduplicated and/or compressed, second key encrypted data in the storage memory 118.

Read data from the storage system 116 follows the read path 204 from the storage memory 118. Thus, the second key encrypted data in the storage memory is read from the storage memory 118 in a retrieval of the stored data, followed by decryption with the storage local second key, data decompression and/or data reconstitution, and encryption with the shared first key. The first key encrypted data 114 is then sent from the storage system 116 to the host 110.

FIG. 3 is a system block diagram showing hosts 110 directly communicating keys 304, 306, 308 to a storage system 116, in a further embodiment of the system of FIG. 1 without the data security management system 102. Variations could have just one host 110, or many hosts 110. The storage system 116 stores first keys 302, for example in memory, and also has a storage local second key 120, stored in memory. In one embodiment, the storage system 116 tracks which host 110 is sending read or write requests, and applies the appropriate first key 304, 306, 308 (e.g., first key A 304, first key B 306 or first key N 308) to decrypt the first key encrypted data 114 sent by that host 110, or encrypt data being sent to a host 110. Other operations and modules, etc., are similar to those described in FIGS. 1 and 2.

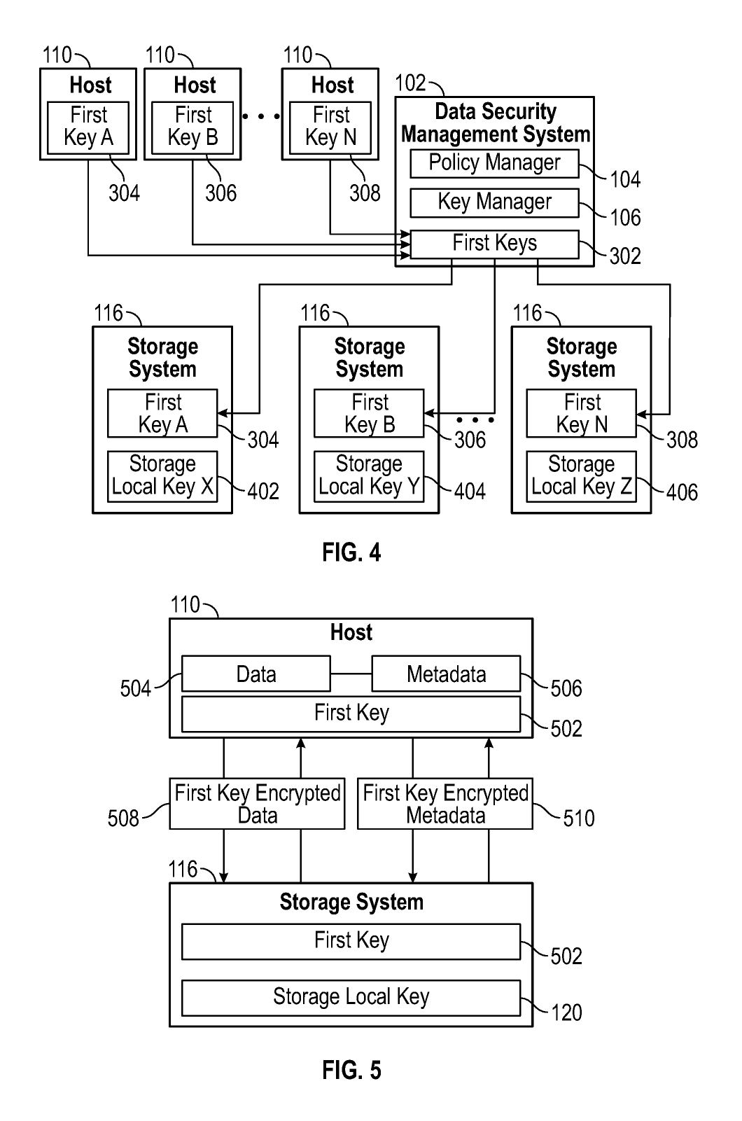

FIG. 4 is a system diagram showing extended key sharing coordinated by a data security management system 102, with multiple hosts 110, multiple keys 304, 306, 308 and multiple storage systems 116, in a further embodiment of the system of FIG. 1. Here, each host 110 sends a first key that is generated or otherwise sourced by that host 110, to the data security management system 102, which stores these in memory as first keys 302. For example, one host 110 sends first key A 304, another host 110 sends first key B 306, and so on up through a host 110 that sends first key N 308, to the data security management system 102. The key manager 106 of the data security management system 102 coordinates the distribution of the first keys 302 to the various storage systems 116, in accordance with the policy manager 104 and the policies 122. In some embodiments, the host system(s) and/or the storage system(s) are key management interoperability protocol (KMIP) clients.

For example, to manage the keys, the key manager 106 could determine, in cooperation with the policy manager 104, that the host 110 with the first key A 304 is writing to and reading from the left-most storage system 116 in FIG. 4. So, the key manager 106 could send the first key A 304 to that storage system 116, which then uses the first key A 304 and the storage local key X 402 in a manner similar to that described with respect to FIGS. 1 and 2. Similarly, the key manager 106 could determine that the host 110 with the first key B 306 is writing to and reading from the middle storage system 116 in FIG. 4, and send the first key B 306 to that storage system 116, which uses the first key B 306 and a storage local key Y 404. And, the key manager 106 could determine that the host 110 with the first key N 308 is writing to and reading from the write-most storage system 116 in FIG. 4, and send the first key N 308 to that storage system 116, which uses the first key N 308 and a storage local key Z 406. In variations, hosts 110 could read and write to differing storage systems 116, with appropriate distribution of first keys 302 by the key manager 106 in accordance with the policy manager 104. For example, a host 110 could be allowed to write to one or more storage systems 116 and read from those or differing storage systems 116, with appropriate distribution of first keys. Another embodiment has multiple first keys for each of one or more hosts, and each first key is specific to one or more blocks or chunks of write data for encryption by that host, and decryption by a targeted storage system 116, with the first keys managed by the data security management system 102. Read data is handled in a related manner.

In the embodiment shown in FIG. 4, each storage system 116 has a second key local to that storage system 116. But, variations to this and further embodiments could be devised in which there are shared second keys, which could be managed by the storage systems, or managed by the data security management system 102.

FIG. 5 is a system diagram showing transmission of both encrypted data and encrypted metadata between host 110 and storage system 116, in an embodiment applicable to variations of FIGS. 1-4. In other systems, typically a host 110 may encrypt data and send encrypted data to a storage system 116, but does not encrypt metadata such as filename, permissions, timestamp or other information about a file, when writing to the storage system 116. In the embodiment shown in FIG. 5, the host 110 encrypts the data 504, using the first key 502, and sends first key encrypted data 508 to the storage system 116 for storage. Also, the host 110 encrypts metadata 506 relating to the data 504, using the first key 502, and sends first key encrypted metadata 510 to the storage system 116 for storage. Key management is performed as described for the data security management system 102 in various embodiments in FIGS. 1-4. In further embodiments, differing first keys could be used for encrypting the data and the metadata, or differing first keys could be used for block specific encryption.

For writing data from the host 110 to the storage memory 118 (see FIG. 1), the storage system 116 uses the first key 502 to decrypt the first key encrypted data 508, which is then deduplicated and/or compressed, followed by encryption using the storage local second key 120 as described above with reference to FIGS. 1 and 2. And, the storage system 116 uses the first key 502 to decrypt the first key encrypted metadata 510, which is then deduplicated and/or compressed, followed by encryption using the storage local key 120. In a variation, the storage system 116 has context aware information about the metadata, and does not apply deduplication or compression to the first key encrypted metadata 510 after decryption with the first key 502, and only re-encrypts the decrypted metadata with the storage local key 120 prior to storage in the storage memory 118 (see FIG. 1).

For reading data from the storage memory 118 to the host 110, the reverse path is followed, as the storage system 116 decrypts the second key encrypted data retrieved from the storage memory 118, using the storage local key 120, followed by decompression and/or reconstitution of the data, and encryption using the first key 502, with the storage system 116 sending first key encrypted data to the host 110. Similarly, the storage system 116 decrypts the second key encrypted metadata retrieved from the storage memory 118, using the storage local key 120, followed by decompression and/or reconstitution of the metadata in embodiments where the metadata was deduplicated and/or compressed prior to storage. Finally the storage system encrypts the measured data, using the first key 502, and sends first key encrypted metadata 510 to the host 110.

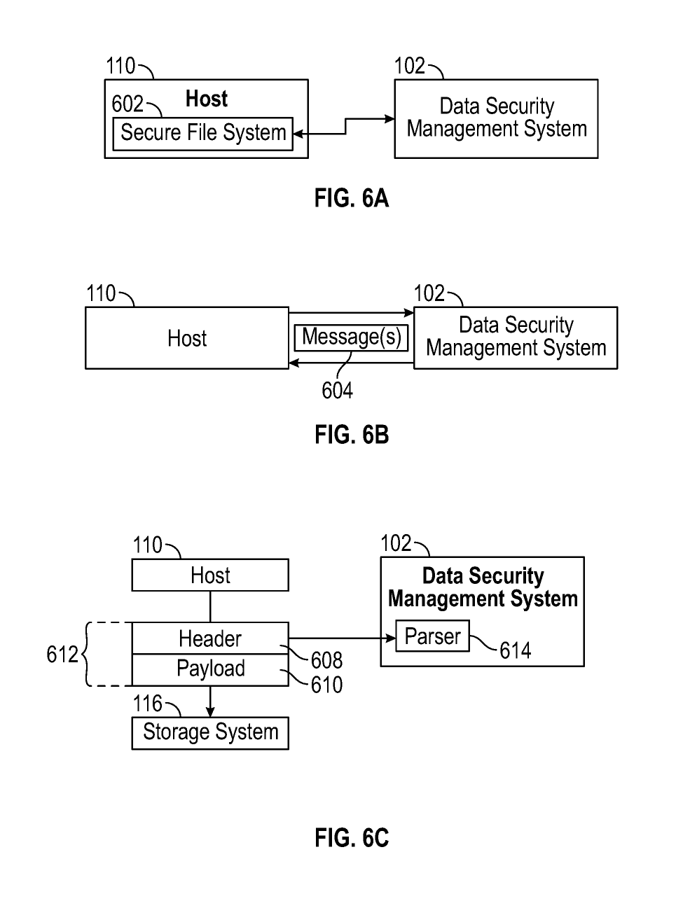

FIGS. 6A-6E show various mechanisms for determining which file or data from which host 110 uses which key for encryption by the host 110 and decryption by the storage system 116 to which the file or data is sent by the host 110 in the case of data write, or encryption by the storage system 116 and decryption by the host 110 that receives the file or data, in the case of data read. These mechanisms can be used in various embodiments of the system described with reference to FIGS. 1-5, so that one or more keys can be managed and distributed. In some embodiments, these mechanisms are used for determining, verifying, implementing or modifying portions of the policies 122 (see FIG. 1) used by the policy manager 104 in the data security management system 102.

FIG. 6A depicts a modified file system 602 communicating with the data security management system 102. Communication could be by messages, data access, request, etc. For example, the secure file system 602 could communicate to the data security management system 102 each time a file or data is written by the host 110 to a storage system 116, and each time a file or data is requested to be read from a storage system 116 to the host 110. In some embodiments, communication could be to initially establish usage of a storage system 116 by the host 110, and again to announce changes. FIG. 6B depicts the host 110 communicating with the data security management system 102, using messages 604. These messages 604 could communicate as described above with reference to FIG. 6A, but originate from the host 110 rather than from a file system, in some embodiments.

In some embodiments agents in the host 110 and the storage system 116 may facilitate communicating with each other. For example, an agent in the host 110 could access information in the file system, without actually requiring any modification of the file system in some embodiments. Communication could allow the storage system 116 to determine which key to use in some embodiments. Agents in the host 110 and the storage system 116 may facilitate communicating with the data security management system 102 in some embodiments. Communication among the agents and the data security management system 102 enables the data security management system 102 to determine which key or keys go where and how the keys are to be used in some embodiments.

FIG. 6C depicts the data security management system 102 intercepting a network packet 612 sent by the host 110 to the storage system 116, and parsing the header 608. In this example, the header 608 has information about the payload 610, which could be a file or data. By parsing the header 608, using a parser 614, the data security management system 102 can determine which host 110 sent the packet 612, the destination storage system 116 for the packet 612, and which key the storage system 116 should have.

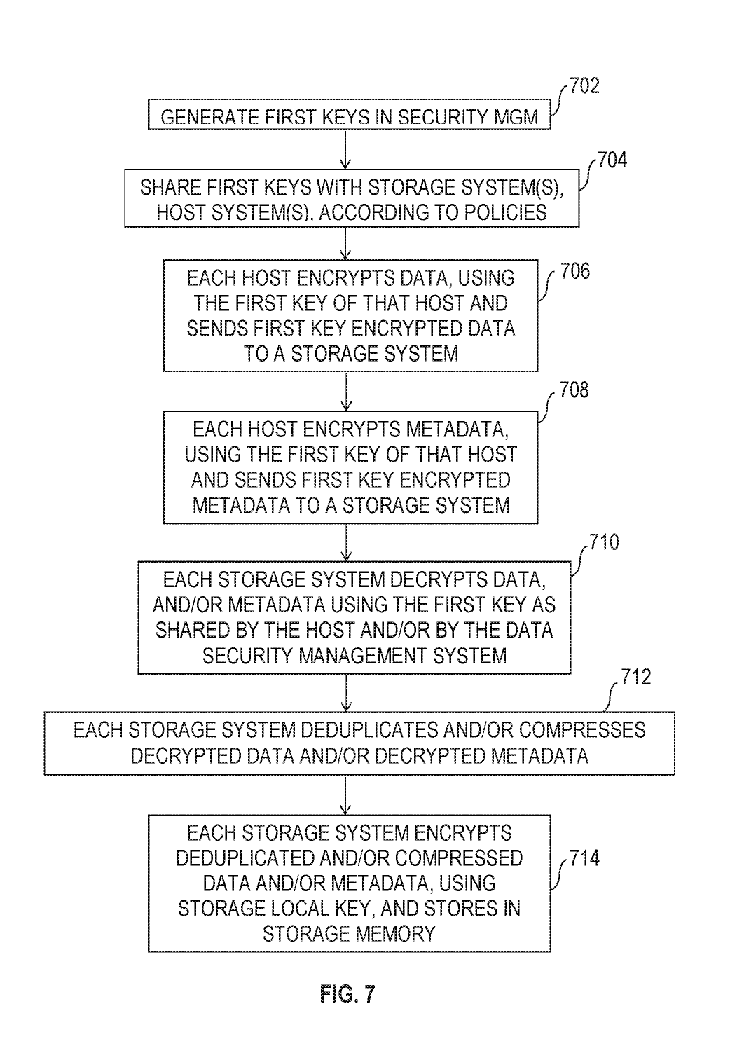

FIG. 7 is a flow diagram of a method for key sharing, which can be performed by a data security management system in cooperation with one or more hosts and one or more storage systems. The method can be performed by one or more processors, for example processors in a data security management system, hosts and storage systems. In various embodiments, the data security management system is a network device, also referred to as a security manager or security device, and communicates with the host(s) and storage system(s) via a network. In an action 702, the data security management system generates keys. In an action 704, the data security management system shares the generated keys with one or more storage systems and one or more host systems, according to policies.

In an action 706, each host encrypts data, using the key of that host, and sends the key encrypted data to a storage system. In an action 708, each host encrypts metadata, using the key of that host, and sends the key encrypted metadata to a storage system. This could be the same or a differing storage system in various embodiments. In an action 710, each storage system decrypts the data, using the first key, as shared by the host and/or by the data security management system. In an action 710, each storage system can also decrypt the metadata, using the first key, as shared by the host and/or by the data security management system.

In an action 712 each storage system deduplicates and/or compresses the decrypted data and/or decrypted metadata. In an action 714, each storage system encrypts deduplicated and/or compressed data and/or metadata, using a local storage key, and stores the local storage key encrypted, deduplicated and/or compressed data and/or metadata in storage memory.

In a further method, the majority of the above steps are reversed, for reading data and/or metadata from a storage system to a host. In further methods, subsets or variations of the above actions are applied to methods for a single host and a single storage system, with or without a data security management system, a method in which data is encrypted but metadata is not encrypted by the host, and a method in which individual blocks or chunks of data are associated with individual first keys for a storage system. Still further methods include a method in which second keys are managed by the data security management system, methods in which keys are generated by hosts, methods in which keys are generated by the data security management system, methods in which the keys are generated by the storage systems, and methods in which various mechanisms described above for communication among hosts, the data security management system and/or the storage system(s) are used for determining the sharing of the various keys.

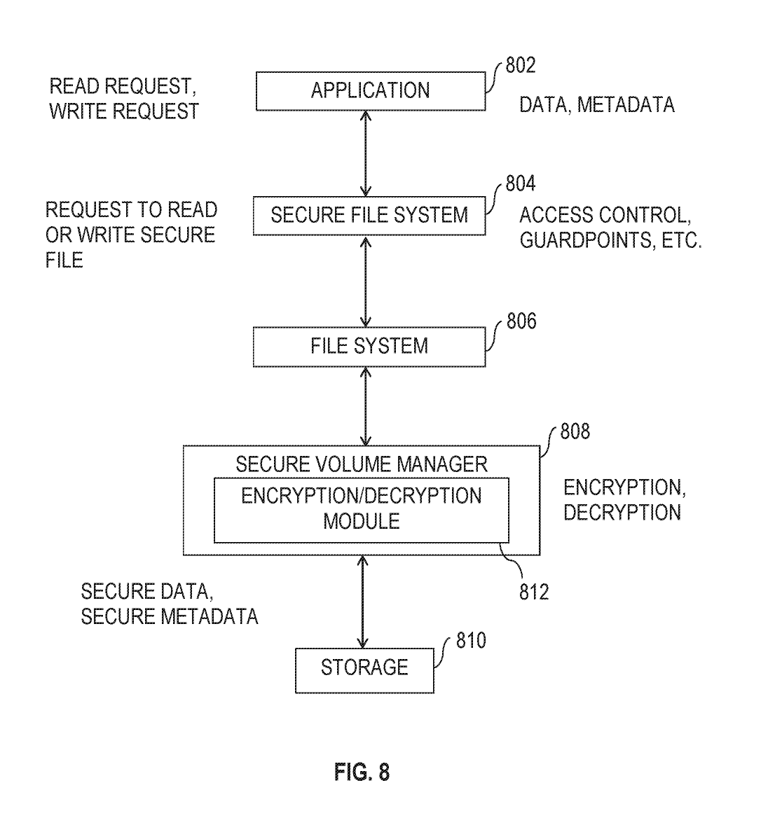

FIG. 8 is a system diagram depicting a secure volume manager 808 encrypting data and encrypting metadata, for storage. This system can be used as shown, or in combination with an embodiment of the key sharing system shown in FIGS. 1-7. Particularly, one embodiment combines the system shown in FIG. 5 and the system shown in FIG. 8, for a system that has key sharing and encryption and decryption of both data and metadata. Further embodiments combine the variations of key sharing systems shown in FIGS. 1-4, the encryption and decryption of both data and metadata of FIG. 5, and the secure data system of FIG. 8.

In FIG. 8, an application 802 (e.g., operating on a host 110 of FIG. 1 or FIGS. 3-7) produces a read request for data to be read from the storage 810, or a write request, for data to be written to the storage 810 (e.g., storage system 116 and storage memory 118 in FIG. 1). It is desired that the data and the metadata relating to the data (e.g., filename, permissions, timestamp, file size, file type, file owner, block identifiers, etc.) be sent in secure form to the storage 810, for example over a network. The application sends the read request or the write request to a secure file system 804. The secure file system 804 has access control, using guard points, etc., and uses the metadata in unencrypted form to determine whether or not to approve a read request or a write request. After verifying appropriate access control, the secure file system 804 sends the request to read or write a secure file through I/O (input/output) to the file system 806, which then sends the request to the secure volume manager 808.

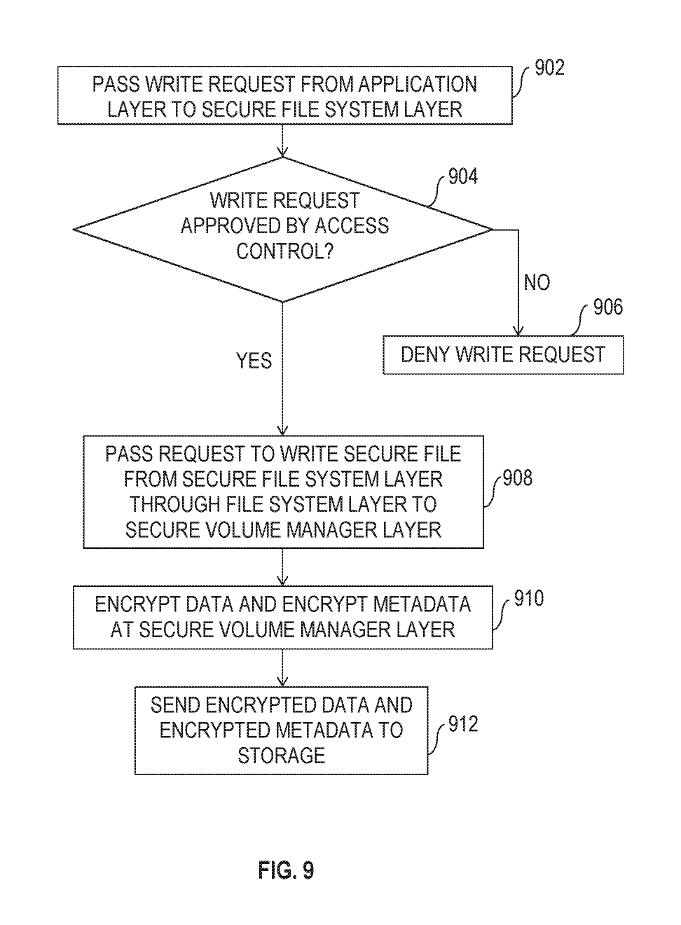

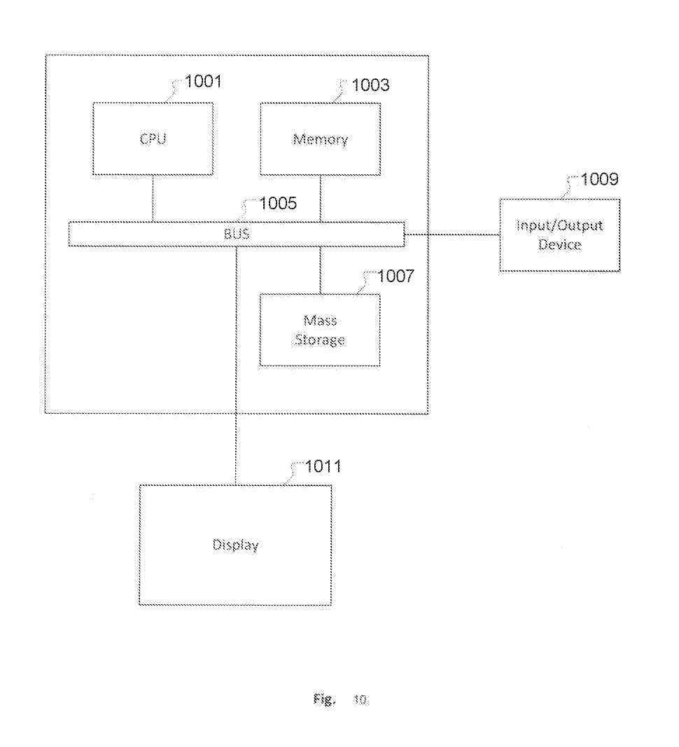

The secure volume manager 808 has an encryption/decryption module 812, and appropriate key(s). In one embodiment, keys are managed as described above with reference to FIGS. 1-7 in a key sharing system. For the write request, the secure volume manager 808 performs encryption, i.e., encrypts the data and encrypts the metadata, and sends secure (encrypted) data and secure (encrypted) metadata to the storage 810. For the read request, the secure volume manager 808 requests the secure data and the secure metadata from the storage 810, and performs decryption, i.e., decrypts the encrypted data and decrypts the encrypted metadata received from the storage 810. The secure volume manager 808 passes the decrypted data and the decrypted metadata up through the filesystem 806, through the secure file system 804, to the application 802. The above processes can be performed by one or more processors, using system layers, for example an application layer, a secure file system layer, a file system layer, and a secure volume manager layer, as described below with reference to FIG. 9. Thus, only secure data and secure metadata, not unencrypted data and not unencrypted metadata, are sent over a network to storage 810. In some embodiments the encrypted data and the encrypted metadata are handled in a combined flow, in other embodiments, these are handled in separate flows.

The above system solves multiple problems. A first problem is that, if the application 802 encrypted the metadata, the secure file system 804 would not have access to unencrypted metadata for use in access control and guard points. Also, a system administrator would not have access to unencrypted metadata to see file information. A second problem is that, if the application 802, the secure file system 804 or the file system 806 encrypted the metadata, the metadata would not necessarily be aligned along 512 byte boundaries that the storage 810 prefers for decryption and compression as described above with reference to FIGS. 1-7. A third problem is that, if data is encrypted but metadata is not, and both of these are sent to storage 810, the storage 810 sees only data blocks and does not have knowledge to understand that the encrypted data should be decrypted for compression but the unencrypted metadata should not be decrypted for compression. These problems are solved by having the secure volume manager 808 perform encryption, for both data and metadata being sent to storage 810, and decryption, for both data and metadata being retrieved from the storage 810, so that the storage 810 sees encrypted blocks of both data and metadata, aligned along the appropriate byte boundaries, and can correctly perform decryption and compression as described above.

FIG. 9 is a flow diagram of a method for encrypting data and metadata, which can be practiced using the system depicted in FIG. 8 and can also be practiced using the key sharing depicted in FIGS. 1-7. The method can be practiced by one or more processors, in a secure data system. In an action 902, a write request is passed from an application layer down to a secure file system layer. In a determination action 904, it is determined whether the write request is approved by access control, at the secure file system layer. If the answer is no, the write request is not approved by access control, then the write request is denied, in an action 906. If the answer is yes, the write request is approved by access control, and flow proceeds to the action 908. In the action 908, a request to write a secure file is passed from the secure file system layer through the file system layer to the secure volume manager layer. In an action 910, data is encrypted and metadata is encrypted at the secure volume manager layer. The encrypted data and the encrypted metadata are sent to storage, in an action 912. A related method for a read request is readily devised by passing and approving a read request in the above steps and applying decryption to encrypted data and encrypted metadata read from the storage, then passing the decrypted data and the decrypted metadata through to the application layer.

It should be appreciated that the methods described herein may be performed with a digital processing system, such as a conventional, general-purpose computer system. Special purpose computers, which are designed or programmed to perform only one function may be used in the alternative. FIG. 10 is an illustration showing an exemplary computing device which may implement the embodiments described herein. The computing device of FIG. 10 may be used to perform embodiments of the functionality for key sharing for a storage system, and/or encryption and decryption of both data and metadata, in accordance with some embodiments. The computing device includes a central processing unit (CPU) 1001, which is coupled through a bus 1005 to a memory 1003, and mass storage device 1007. Mass storage device 1007 represents a persistent data storage device such as a floppy disc drive or a fixed disc drive, which may be local or remote in some embodiments. Memory 1003 may include read only memory, random access memory, etc. Applications resident on the computing device may be stored on or accessed via a computer readable medium such as memory 1003 or mass storage device 1007 in some embodiments. Applications may also be in the form of modulated electronic signals modulated accessed via a network modem or other network interface of the computing device. It should be appreciated that CPU 1001 may be embodied in a general-purpose processor, a special purpose processor, or a specially programmed logic device in some embodiments.

Display 1011 is in communication with CPU 1001, memory 1003, and mass storage device 1007, through bus 1005. Display 1011 is configured to display any visualization tools or reports associated with the system described herein. Input/output device 1009 is coupled to bus 1005 in order to communicate information in command selections to CPU 1001. It should be appreciated that data to and from external devices may be communicated through the input/output device 1009. CPU 1001 can be defined to execute the functionality described herein to enable the functionality described with reference to FIGS. 1-9. The code embodying this functionality may be stored within memory 1003 or mass storage device 1007 for execution by a processor such as CPU 1001 in some embodiments. The operating system on the computing device may be MS DOS™, MS-WINDOWS™ OS/2™, UNIX™, LINUX™, or other known operating systems. It should be appreciated that the embodiments described herein may also be integrated with a virtualized computing system implemented with physical computing resources.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

A module, an application, a layer, an agent or other method-operable entity could be implemented as hardware, firmware, or a processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer or an agent.

The embodiments can also be embodied as computer readable code on a tangible non-transitory computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

In various embodiments, one or more portions of the methods and mechanisms described herein may form part of a cloud-computing environment. In such embodiments, resources may be provided over the Internet as services according to one or more various models. Such models may include Infrastructure as a Service (IaaS), Platform as a Service (PaaS), and Software as a Service (SaaS). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

Various units, circuits, or other components may be described or claimed as “configured to” perform a task or tasks. In such contexts, the phrase “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method for key sharing with a storage system, performed by a security manager, comprising:
sharing a first key with a host system; and
sharing the first key with a storage system, so that the host system encrypts a file or data with the first key and sends the encrypted file or data to the storage system, the storage system decrypts the encrypted file or data with the first key, compresses the decrypted file or data, and re-encrypts the decrypted file or data.

2. The method of claim 1, further comprising:
sharing a second key with a further host system; and
sharing the second key with a further storage system, so that the further host system encrypts a further file or data with the second key and sends the encrypted further file or data to the further storage system, the further storage system decrypts the encrypted further file or data with the third key, compresses the decrypted further file or data, re-encrypts the compressed decrypted further file or data, wherein the host, further host, storage system and the further storage system are key management interoperability protocol (KMIP) clients.

3. The method of claim 1, wherein the sharing the first key with the storage system so that the host system encrypts metadata relating to the file or data with the first key and sends the encrypted metadata to the storage system, the storage system decrypts the encrypted metadata with the first key, compresses the decrypted metadata, re-encrypts the compressed metadata.

4. The method of claim 1, further comprising:
tracking which key, of a plurality of keys including the first key, is shared by which of a plurality of host and storage systems.

5. The method of claim 1, wherein sharing the first key with the host system and the storage system comprises:
host receiving the first key from the security manager; and
storage system receiving the first key from the security manager

6. The method of claim 1, further comprising:
sharing the first key with a plurality of storage systems.

7. The method of claim 1, further comprising:
sharing a plurality of keys, including the first key, with the storage system, wherein the storage system uses each of the plurality of keys to decrypt one or more blocks or chunks of data received from the host system.

8. The method of claim 1, wherein the storage system parses headers in network packets containing storage requests from the host system and extracts information regarding association of keys to blocks of data.

9. A security manager, comprising:
a network device, connectable to a network and having at least one processor; and
the at least one processor configured to share a first key with a host system and share the first key with a storage system that is configured to receive a file encrypted by the host system with the first key and decrypt the encrypted file with the first key.

10. The security manager of claim 9, further comprising:
the at least one processor further configured to share a second key with a further host system and share the second key with a further storage system, with the further host system configured to encrypt a further file or data with the second key and send the encrypted further file or data to the further storage system wherein the host, further host, storage system and the further storage system are key management interoperability protocol (KMIP) clients.

11. The security manager of claim 9, wherein:
the host system is configured to encrypt metadata relating to the file or data with the first key and send the encrypted metadata to the storage system; and
the storage system is configured to decrypt the encrypted metadata with the first key, compress the decrypted metadata, reencrypt the compressed.

12. The security manager of claim 9, further comprising:
the at least one processor further configured to track a plurality of keys including the first key, including tracking which key of the plurality of keys is used by which storage system of a plurality of storage systems that includes the storage system, and share the plurality of keys among the plurality of storage systems in accordance with the tracking.

13. The security manager of claim 9, further comprising:
the at least one processor further configured to track a plurality of keys including the first key, including tracking which key of the plurality of keys is used by which host system of a plurality of host systems that includes the host system, and share the plurality of keys among the plurality of host systems in accordance with the tracking.

14. The security manager of claim 9, further comprising:
the at least one processor further configured to track a plurality of keys including the first key, wherein the storage system is configured to associate each of the plurality of keys with one or more blocks or chunks of data.

15. The security manager of claim 9, wherein the at least one processor configured to share the first key with the host system and the storage system comprises:
the at least one processor configured to generate the first key and send the first key to the storage system and the host system.

16. The security manager of claim 9, further comprising:
the at least one processor configured to share the first key with a plurality of storage systems, including the storage system.

17. A method for key sharing with a plurality of storage systems, performed by a security manager, comprising:
generating a plurality of keys;
determining which storage system, of the plurality of storage systems, or which host system, of a plurality of host systems, uses which key or keys, of the plurality of keys; and
distributing the plurality of keys, in accordance with the determining, so that each storage system, of the plurality of storage systems, can receive a file or data encrypted with a first key by a host system, decrypt the encrypted file or data with the first key, compress the decrypted file or data, reencrypt the compressed decrypted file or data.

18. The method of claim 17, wherein the determining comprises:
communicating with the plurality of host systems which have a plurality of file systems.

19. The method of claim 17, wherein each of the plurality of storage systems and host systems is a key management interoperability protocol (KMIP) client.

20. A method for encryption, performed by a secure data system, comprising:
passing a write request from an application layer to a secure file system layer;
determining that the write request is approved by access control, at the secure file system layer;
passing a request to write a secure file, from the secure file system layer through a file system layer to a secure volume manager layer;
encrypting data and encrypting metadata relating to the data, at the secure volume manager layer; and
sending the encrypted data and the encrypted metadata from the secure volume manager layer to storage.

21. The method of claim 20, further comprising:
passing a read request from the application layer to the secure file system layer;
determining that the read request is approved by the access control, at the secure file system layer;
passing a request to read the secure file, from the secure file system layer through the file system layer to the secure volume manager layer;
reading the encrypted data and the encrypted metadata from the storage;
decrypting the encrypted data and decrypting the encrypted metadata, at the secure volume manager layer; and
passing the decrypted data and the decrypted metadata, from the secure volume manager layer through the file system layer and through the secure file system layer to the application layer.

22. The method of claim 20, wherein the determining that the write request is approved by access control, at the secure file system layer, is based on the metadata relating to the data, with the metadata in unencrypted form.

23. The method of claim 20, further comprising:
receiving a plurality of keys from a plurality of host systems, with one of the host systems hosting an application at the application layer and the application generating the data and the metadata relating to the data; and
determining and sending a key, of the plurality of keys, to the storage system for use in decrypting the encrypted data and decrypting the encrypted metadata, wherein the encrypting the data and the encrypting the metadata use the key at the secure volume manager layer.

24. The method of claim 20, further comprising:
sharing a key with a host system that generates the data and the metadata relating to the data; and
sharing the key with the storage, in accordance with one or more policies, wherein the encrypting the data and the encrypting the metadata relating to the data, at the secure volume manager layer, uses the shared key, and wherein the storage uses the shared key to decrypt the encrypted data and decrypt the encrypted metadata.
